(19) United States
(12) Patent Application Publication
(10) Pub. No.: US 2025/0018480 A1
(43) Pub. Date: Jan. 16, 2025

(54) Rotary Tool and Method for Manufacturing Such a Rotary Tool

(71) Applicant: KENNAMETAL INC., Latrobe, PA (US)

(72) Inventors: Herbert Rudolf Kauper, Fuerth (DE); Jürgen Schwägerl, Vohenstrauss (DE); Christian Strauchmann, Fuerth (DE)

(21) Appl. No.: 18/221,049

(22) Filed: Jul. 12, 2023

(51) Int. Cl. B23B 51/02

(52) U.S. Cl. CPC B23B 51/02; B23B 2251/04; B23B 2251/408

(57) ABSTRACT

A rotary tool (2) is provided, comprising: a main blade (4), a chip flute (6), a lateral surface (8), a flank (10) trailing the main blade (4) and extending from the main blade (4) up to the lateral surface (8) and to the chip flute (6), wherein the flank (10) comprises a kink (12) and is thus concave in configuration, wherein the kink (12) extends from the lateral surface (8) up to the chip flute (6) and thus divides the flank (10) into a leading partial surface (14) and a trailing partial surface (16). The invention further relates to a method for manufacturing such a rotary tool (2).

### RELATED APPLICATION DATA

The present application claims priority under 35 U.S.C. § 119 to German Patent Application No. 102022207652.4, filed Jul. 26, 2022 the disclosure of which is incorporated by reference herein in its entirety.

### FIELD

The invention relates to a rotary tool and a method for manufacturing such a rotary tool.

### BACKGROUND

An example of a rotary tool is a drill. Such a rotary tool regularly comprises a number of main blades that engage with the workpiece while in operation and lift a chip from the workpiece. The main blade and its cutting behavior are determined, among other things, by a flank, which, proceeding from the main blade, trails after it and, together with a cutting plane perpendicular to the longitudinal axis of the rotary tool, defines the so-called clearance angle.

The larger the clearance angle, the steeper the clearance surface will decrease and the stronger the body of the rotary tool will be truncated. A large clearance angle is advantageous on the one hand, but also leads to the disadvantage that the rotary tool is less stable during operation.

### SUMMARY

In light of the foregoing, the problem addressed by the invention is to specify an improved rotary tool as well as a suitable method for its manufacture. In particular, the disadvantage described above is to be minimized.

The problem is solved according to the invention by a rotary tool having the features according to claim 1 and by a method having the features according to claim 12. Advantageous configurations, further developments, and variants are the subject matter of the subclaims. The statements made in connection with the rotary tool also apply to the method and vice versa.

The rotary tool comprises a main blade, a chip flute, a lateral surface, and a flank, which are in particular respectively part of a body of the rotary tool. The flank and the main blade are part of a tool tip of the rotary tool, which is configured on the front side of the body. The body generally extends in a longitudinal direction and along a longitudinal axis, about which the rotary tool rotates in a circumferential direction while in operation. The lateral surface bounds the body in the radial direction, i.e., perpendicular to the longitudinal direction. The main blade is configured on the front side of the body, extends roughly in the radial direction, and terminates in particular at the lateral surface. While in operation, the main blade engages with a workpiece in order to lift a chip off of the latter, which is then transported away in particular via a different chip flute.

The flank trails after the main blade (i.e., lies behind it in relation to the circumferential direction) and extends from the main blade up to the lateral surface and to the chip flute. This flute is in particular not the chip flute that adjoins the aforementioned main blade and leads up to it, but in particular a chip flute of a further main blade of the rotary tool, i.e., the chip flute meant here trails after the main blade meant here. The flank is generally arranged on the front side and faces forward, thus forming the face of the rotary tool, so to speak. While in operation, the flank forms the so-called clearance angle with a cutting plane perpendicular to the longitudinal direction.

In the present case, the flank comprises a kink and is thus concave in configuration. As a result, the flank thus forms a clearance angle, which varies in the circumferential direction. The kink is preferably configured in the manner of a hollow fillet. The kink extends from the lateral surface up to the chip flute and thus divides the flank into a leading partial surface and a trailing partial surface. This is understood to mean that the trailing partial surface trails after the leading partial surface and also after the kink, and analogously the leading partial surface leads up to the trailing partial surface and the kink. The leading partial surface is thus arranged in the circumferential direction between the main blade and the trailing partial surface.

In general, “A is trailing (relative to B)” or “A trails after B” means that A lies behind B in relation to the circumferential direction. Conversely, “A is protruding (relative to B)” or “A is B protruding” is understood to mean that A is ahead of B in terms of the circumferential direction.

The kink extends from the lateral surface up to the chip flute preferably continuously and without interruption. To the extent that the rotary tool comprises a tip on the front side, this is considered a part of the chip flute in the present case for the sake of simplicity. In a suitable embodiment, the kink then extends from the lateral surface, especially up to the tip. Preferably, the kink has a predominantly straight profile. The leading partial surface in particular directly adjoins the main blade, preferably along an entire length of the main blade. The trailing partial surface is in particular not in contact with the main blade. The kink preferably extends parallel to the main blade, so that the leading partial surface is configured as a strip, so to speak. Preferably, the flank only comprises the one aforementioned kink and otherwise no further kinks.

One advantage of the invention is in particular that the design freedom of the flank is increased by the kink, thereby affording an additional degree of freedom for the profile of the flank and especially for the clearance angle. Before and after the kink, different clearance angles result along the flank, which are advantageously adjusted independently from one another during manufacture. During the manufacture of the rotary tool, in particular by grinding, material is removed from the front side of the body in order to form the main blade and the flank and also overall the tool tip on the front side of the rotary tool. The concave design of the flank now removes less material than with a straight flank, so that the body protrudes further in comparison. Instead of substantially maintaining the clearance angle over the entire flank, in the present case the clearance surface is intentionally kinked over so that the clearance angle decreases starting from the main blade and on the kink when viewed counter to the circumferential direction. In other words, the trailing and the leading partial surface have different clearance angles, and the clearance angle of the trailing partial surface is less than the clearance angle of the leading partial surface, at least in the direct vicinity of the kink. This results in increased stability of the rotary tool in operation. In addition, the chip flute is extended towards the tip of the rotary tool, and the formation and removal of a chip via the chip flute is improved. In a rotary tool with a coolant channel that opens up in the flank, the coolant supply therefrom also occurs closer to the main blade, because the flank generally lies further forward than a straight flank.

In one suitable configuration, the leading partial surface and the trailing partial surface are arranged at a reflex angle to one another. The two partial surfaces converge on the kink and accordingly form an angle there, wherein the angle is measured at the rear side, i.e., measured on the body side, i.e., rearward in the longitudinal direction and into the body. This angle is now a reflex angle, i.e., greater than 180° and less than 360°. Suitably, the angle is greater than 180° and less than 230°. The angle between the two partial surfaces defines the change in the clearance angle on principle when transitioning from one partial surface to the other. The angle is not necessarily constant along the kink, but varies. In one suitable configuration, the angle increases along the kink and towards the lateral surface; this is independent of whether the angle is reflex or not.

In one suitable configuration, the leading partial surface is also convex, i.e., curved outwardly or bulged forward in the longitudinal direction. In other words, the leading partial surface is progressively configured, i.e., with a progressively varying clearance angle. As a result, the leading partial surface decreases rearwards, so to speak, starting from the main blade, and the clearance angle increases over its course counter to the circumferential direction and towards the kink. Thus, in combination with the concave configuration of the flank by the kink, starting from the main blade, a total convex-concave profile results, in which the flank initially decreases more and more in the direction of the kink counter to the circumferential direction (convex leading partial surface) and then, so to speak suddenly, flattens at the kink (concave flank due to the kink). By contrast, the trailing partial surface is preferably predominantly straight, i.e., neither concave nor convex, except in particular for a generally tapered shape, which may result from a generally tapered shape of the tool tip.

The clearance angle along the leading partial surface is suitably 5° to 50°. In one advantageous embodiment, the clearance angle at the main blade is 5° to 20° and preferably increases continuously (i.e., not in discrete increments) to 30° to 50° up to the kink. The clearance angle along the trailing partial surface is suitably 0° to 10°. The clearance angle is preferably constant along the trailing partial surface, but a variation, e.g., similar to the leading partial surface, may also be advantageous. Conversely, a straight profile is also advantageous for the leading partial surface instead of the progressive profile described above, e.g., with one to three partial surfaces. “Profile” is generally understood to mean a profile along the circumferential direction, i.e., circularly about the longitudinal axis.

Preferably, the flank is configured overall without edges. Preferably, the kink is rounded in configuration and, in a suitable configuration, has a radius of curvature of at least 0.1 mm and/or at most 25% of the diameter (measured in the radial direction, i.e., overall diameter) of the rotary tool for this purpose. The radius of curvature is in particular less than a radius of curvature of the leading partial surface, provided that it is curved and e.g., convex, as described above. The radius of curvature is preferably constant along the curvature; this is in particular a result of the manufacturing process; however, a varying radius of curvature is generally also suitable.

The flank and the lateral surface are connected via a circumferential edge, which forms in particular a cutting corner with the main blade. An ancillary blade, which is a part of a main guide chamfer of the lateral surface, preferably also terminates at the cutting corner.

When measured in the longitudinal direction, the circumferential edge is expediently offset rearwards relative to the cutting corner by a maximum of 25% of the diameter of the rotary tool. This is primarily realized by the kink and as a result the varying clearance angle. By contrast to a continuous, straight flank, the circumferential edge in the present case is significantly less rearwardly offset.

The circumferential edge is divided by the kink into a leading portion and a trailing portion. Preferably, the trailing portion is longer than the leading portion by at least a factor of 2. In particular, the trailing portion is longer than the leading portion by at most a factor of 10. The result is that the kink extends rather close to the main blade and terminates rather close to the longitudinal axis at the chip flute, namely at an inner half of the chip flute, and also that the leading partial surface is generally shorter than the trailing partial surface (measured in particular perpendicular to the main blade and in the center of the latter).

In a suitable configuration, the lateral surface comprises a main guide chamfer and an ancillary guide chamfer for stabilization while in operation. The main guide chamfer proceeds from the main blade and in particular forms the aforementioned cutting corner with the latter. Between the main and the ancillary guide chamfers the lateral surface is offset rearwards in the radial direction R. The ancillary guide chamfer trails after the main guide chamfer and terminates at the trailing partial surface. The ancillary guide chamfer is thus significantly longer compared to a design with a straight flank.

Preferably, the rotary tool comprises at least one coolant channel, with a mouth arranged in the flank and on the kink, or which trails after the kink. The coolant channel extends from a rear side of the body up to the flank, in which the coolant channel terminates via its mouth. Coolant (or, equivalently, lubricant or coolant and lubricant) leaks from the mouth during operation. Due to the special profile of the flank, the mouth is now particularly close to the main blade when viewed in the longitudinal direction, and a better coolant supply results.

Preferably, the rotary tool is a drill. However, the statements made here are generally also applicable to other rotary tools, such as milling machines. The rotary tool described herein preferably comprises two, three, or four main blades, and correspondingly many flutes, lateral surfaces, and flanks. The rotary tool is either integral, i.e., monolithic, or multi-part, e.g., modular with a separable tool tip.

The chip flute, the lateral surface and-if present-the main guide chamfer, the ancillary guide chamfer, and the coolant channel are respectively designed in a coiled manner, i.e., they extend helically about the longitudinal axis.

The method serves to manufacture a rotary tool, in particular a rotary tool as described above. The rotary tool comprises a main blade, a chip flute, a lateral surface, and a flank. In the context of the method, the flank is configured so as to trail after the main blade and extends from the main blade up to the lateral surface and to the chip flute. The flank is configured with a kink and is thus concave. The kink is configured so as to extend from the lateral surface up to the chip flute and thus divides the flank into a leading partial surface and a trailing partial surface.

Preferably, the flank is ingrained into the body of the rotary tool in a grinding step of the method. For this purpose, in particular, a grinding wheel is used, which is guided along a corresponding grinding path and is inclined variously, as needed, is the grinding step.

In principle, it is possible to configure the flank with the kink and, optionally, with a progressive profile of the leading partial surface in different, successive sub-steps, in particular to ingrain it. However, preferably, the entire flank is ingrained in a single grinding step along a single grinding path and with only one grinding wheel. The method is thus particularly efficient, because the flank is manufactured in a single pass. Accordingly, the configuration of the kink is primarily dependent on the selection of the grinding wheel. Especially the possibly concave configuration of the kink and its radius of curvature results from the selection of a grinding wheel with a correspondingly rounded circumferential edge between the lateral surface and the end face of the grinding wheel. However, the angle between the two partial surfaces does not necessarily correspond to an angle between the lateral surface and the end face of the grinding wheel, but is at most larger on principle and is in any case set by the profile of the grinding path and/or a slope of the grinding wheel upon reaching the kink.

### DESCRIPTION OF THE DRAWINGS

Design examples of the invention are explained in more detail in the following with the aid of a drawing. The figures show schematically:

FIG. 1 a rotary tool in a side view,

FIG. 2 the rotary tool of FIG. 1 in a front view,

FIG. 3 a variant of the rotary tool of FIG. 1,

FIG. 4 the rotary tool of FIG. 5 in a front view,

FIG. 5 a different rotary tool,

FIG. 6 the rotary tool of FIG. 5 in a front view,

FIGS. 7 to 9 the manufacture of a rotary tool.

### DETAILED DESCRIPTION

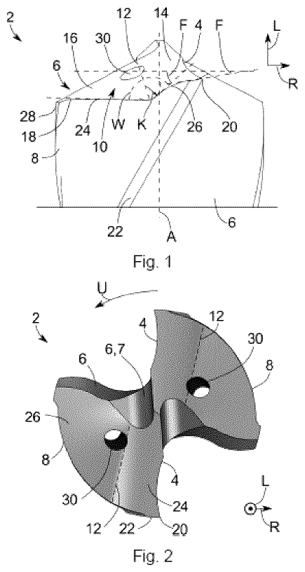

In FIGS. 1 to 6, various exemplary embodiments for a rotary tool 2 are shown in excerpts. The rotary tool 2 comprises two main blades 4, two chip flutes 6, two lateral surfaces 8, and two flanks 10, each of which are part of a body of the rotary tool 2. The following embodiments apply analogously to rotary tools with other numbers of main blades 4, chip flutes 6, lateral surfaces 8, and flanks 10. The flank 10 and the main blade 4 are part of a tool tip of the rotary tool 2, which is configured on the front side of the body. The body generally extends in a longitudinal direction L and along a longitudinal axis A, about which the rotary tool 2 rotates in a circumferential direction U while in operation. The lateral surface 8 bounds the body in the radial direction R, i.e., perpendicular to the longitudinal direction L. The main blade 4 is configured on the front side of the body, extends roughly in the radial direction R, and terminates at the lateral surface 8. While in operation, the main blade 4 engages with a workpiece (not shown) in order to lift a chip (also not shown) off of the latter, which chip is then transported away via one of the chip flutes 6.

The flank 10 trails after the main blade 4 (i.e., lies behind it in relation to the circumferential direction U) and extends from the main blade 4 up to the lateral surface 8 and to one of the chip flutes 6, which trails after the aforementioned main blade 4. The flank 10 is generally arranged on the front side and faces forward and, while in operation, forms the so-called clearance angle with a cutting plane perpendicular to the longitudinal direction L.

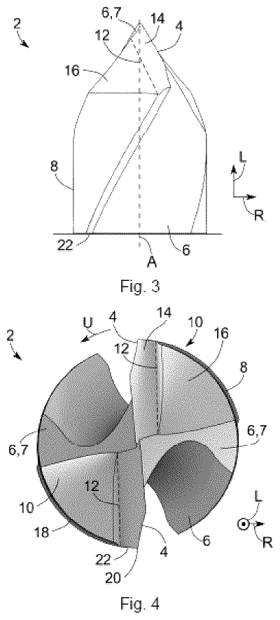

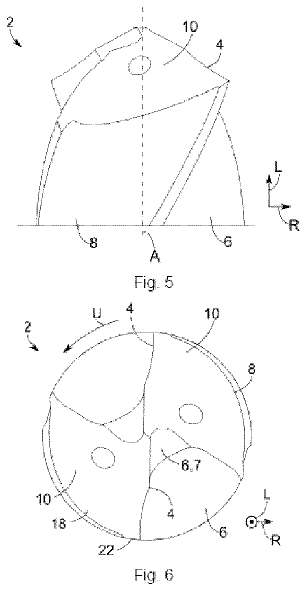

In the present case, the flank 10 comprises a kink 12 and is thus concave in configuration. This can be seen in FIGS. 1 to 6, wherein FIGS. 1 and 2 show a first exemplary embodiment of the invention and FIGS. 3 and 4 show a second exemplary embodiment of the invention. Compared to this, FIGS. 5 and 6 show a rotary tool 2 not according to the invention having flanks 10 without a kink 12. Due to the kink 12, the flank 10 forms a clearance angle F, which varies in the circumferential direction U. Here, the kink 12 is respectively configured in the manner of a hollow fillet and extends from the lateral surface 8 up to the chip flute 6, even to the tip 7 of the rotary tool 2 here, wherein the tip 7 is considered a part of the chip flute 6. As a result, the kink 12 divides the flank 10 into a leading partial surface 14 and a trailing partial surface 16. This is understood to mean that the trailing partial surface 16 trails after the leading partial surface 14 and also after the kink 12, and analogously the leading partial surface 14 leads up to the trailing partial surface 16 and the kink 12. The leading partial surface 14 is thus arranged in the circumferential direction U between the main blade 4 and the trailing partial surface 16.

In the present case, the kink 12 extends from the lateral surface 8 up to the chip flute 6 (more precisely, up to the tip) in a continuous and uninterrupted manner and comprises a predominantly straight profile. The leading partial surface 14 directly adjoins the main blade 4 along an entire length of the latter. The trailing partial surface 16 is not in contact with the main blade 4. The kink 12 extends parallel to the main blade 4, so that the leading partial surface 14 is configured as a strip, so to speak. In the present case, the flank 10 in all exemplary embodiments only comprises the one aforementioned kink 12 and otherwise no further kinks.

As can be seen by a comparison of FIGS. 1 to 4 to FIGS. 5 and 6, due to the concave design of the flank 10, less material is removed during the manufacture of the rotary tool 2 according to FIGS. 1 to 4 than with a straight flank 10, as in the case of FIGS. 5 and 6, so that the body protrudes further in comparison. Instead of substantially maintaining the clearance angle F over the entire flank 10 as in FIGS. 5 and 6, in FIGS. 1 to 4 the clearance surface 10 is intentionally kinked over so that the clearance angle F decreases starting from the main blade 4 and on the kink 12 when viewed counter to the circumferential direction U.

In the exemplary embodiments shown, the leading partial surface 14 and the trailing partial surface 16 are arranged at a reflex angle W to one another. The two partial surfaces 14, 16 converge on the kink 12 and accordingly form an angle W there, wherein the angle W is measured at the rear side, i.e., measured on the body side, i.e., rearward in the longitudinal direction L and into the body. This angle W is a reflex angle, i.e., greater than 180° and less than 360°.

In all exemplary embodiments shown here, the leading partial surface 14 is also convex, i.e., curved outwardly or bulged forward in the longitudinal direction L. In other words, the leading partial surface 14 is configured progressively, i.e., with a progressively varying clearance angle F. As a result, the leading partial surface 14 decreases rearwards from the main blade 4 and the clearance angle F increases over its course counter to the circumferential direction U and towards the kink 12. This is optional, in principle. In combination with the concave configuration of the flank 10 by the kink 12, starting from the main blade 4, a total convex-concave profile results, in which the flank 10 initially decreases more and more in the direction of the kink 12 counter to the circumferential direction U and then flattens at the kink 12. By contrast, the trailing partial surface 16 is respectively predominantly straight, but can also be configured differently.

The clearance angle F along the leading partial surface 14 is for example 5° to 50° and along the trailing partial surface 16 is for example 0° to 10°. In the present case, the clearance angle F is constant along the trailing partial surface 16, but a variation, e.g., similar to the leading partial surface 14, is also possible. Conversely, a straight profile is also possible for the leading partial surface 14 instead of the progressive profile shown as an example here, e.g., with one to three partial surfaces.

The respective flank 10 shown here is configured overall without edges; in particular, the kink 12 is rounded and comprises a radius of curvature K, which is constant along the kink 12.

The flank 10 and the lateral surface 8 are connected via a circumferential edge 18, which forms a cutting corner 20 with the main blade 4. An ancillary blade, which is a part of a main guide chamfer 22 of the lateral surface 8, also terminates at the cutting corner 20. Measured in the longitudinal direction L, the circumferential edge 18 is significantly less rearwardly offset from the cutting corner 20 in FIGS. 1 to 4 compared to FIGS. 5 and 6. This is primarily realized by the kink 12 and as a result the varying clearance angle F.

The circumferential edge 18 is divided by the kink 12 into a leading portion 26 and a trailing portion 26, wherein the trailing portion 26 is longer than the leading portion 24 by at least a factor of 2. The result is that the kink 12 extends rather close to the main blade 4 and terminates rather close to the longitudinal axis A at the chip flute 6, namely at an inner half of the chip flute 6, and also that the leading partial surface 14 is generally shorter than the trailing partial surface 16 (measured perpendicular to the main blade 4 and in the center of the latter).

In the exemplary embodiment of FIGS. 1 and 2, the lateral surface 8 comprises a main guide chamfer 22 and an ancillary guide chamfer 28. The main guide chamfer 22 proceeds from the main blade 4 and forms the aforementioned cutting corner 20 with the latter. Between the main and the ancillary guide chamfers 22, 28, the lateral surface 8 is offset rearwards in the radial direction R. The ancillary guide chamfer 22 trails after the main guide chamfer 28 and terminates at the trailing partial surface 16. The ancillary guide chamfer 28 is thus significantly longer compared to a design with a straight flank 10, e.g., similar to FIGS. 5 and 6.

In the exemplary embodiments shown here, the rotary tool 2 comprises at least one coolant channel, with a mouth 30 arranged in the flank 10 and on the kink 12 (FIGS. 1 and 2) or which trails after the kink 12 (not shown). The coolant channel extends from a rear side of the body up to the flank 10, in which the coolant channel terminates via its mouth 30. Coolant exits from the mouth 30 during operation. Due to the special profile of the flank 10, the mouth 30 is particularly close to the main blade 4 when viewed in the longitudinal direction L.

The rotary tool 2 shown here is a drill, but the designs are generally applicable to other rotary tools 2 as well. The rotary tool 2 is also respectively integral, i.e., monolithic, or, in a variant not shown, multi-part, e.g., modular with a separable tool tip.

Merely by way of example, the chip flutes 6, the lateral surfaces 8, the main guide chamfers 22, the ancillary guide chamfers 28, and the coolant channels are arranged coiled here, i.e., they extend helically around the longitudinal axis A.

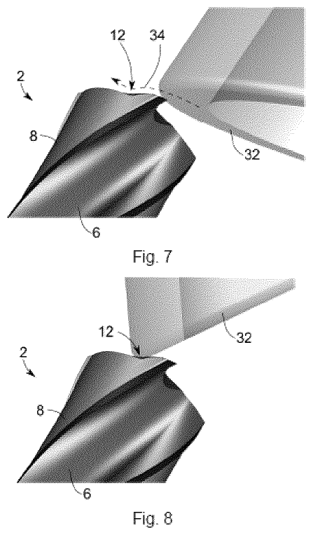

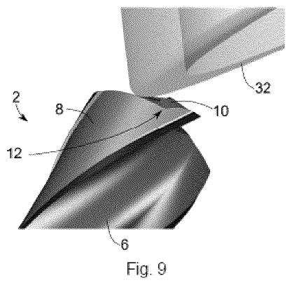

FIGS. 7 to 9 show a method for manufacturing a rotary tool 2 as described above. The flank 10 is ingrained into the body of the rotary tool 2 in a grinding step. For this purpose, a grinding wheel 32 is used, which is guided along a corresponding grinding path 34 and is inclined variously, as needed. In FIGS. 7 to 9, the rotary tool 2 is shown already in the finished state with the kink 12, whereby the grinding path 34 is particularly clarified. In principle, it is possible to ingrain the flank 10 with the kink 12 in different, successive sub-steps. In the present case, however, the entire flank 10 is ingrained in a single grinding step along a single grinding path 34 and with only one grinding wheel 32. Accordingly, FIGS. 7 to 7 show three different positions of the grinding wheel 32 along the grinding path 34 in order to illustrate the ingraining and specifically the manufacture of the kink 12.

1. A rotary tool comprising:
a main blade;
a chip flute;
a lateral surface; and
a flank trailing after the main blade and extending from the main blade up to the lateral surface and to the chip flute, wherein the flank comprises a kink and is thus concave in configuration, and wherein the kink extends from the lateral surface up to the chip flute and thus divides the flank into a leading partial surface and a trailing partial surface.

2. The rotary tool according to claim 1,
wherein the leading partial surface and the trailing partial surface are arranged at a reflex angle to one another, wherein the reflex angle is measured at the rear.

3. The rotary tool according to claim 1,
wherein the leading partial surface and the trailing partial surface are arranged at an angle to one another, wherein that angle is measured at the rear, wherein the angle (W) increases along the kink (12) and towards the lateral surface (8).

4. The rotary tool according to claim 1,
wherein the leading partial surface is concave in configuration.

5. The rotary tool according to claim 1,
wherein the kink is rounded in configuration.

6. The rotary tool according to claim 1,
wherein the flank and the lateral surface are connected via a circumferential edge, which forms a cutting corner with the main blade,
wherein, when measured in the longitudinal direction, the circumferential edge is offset rearwards relative to the cutting corner by a maximum of 25% of a diameter of the rotary tool.

7. The rotary tool according to claim 1,
wherein the flank and the lateral surface are connected via a circumferential edge, which is divided by the kink into a leading portion and a trailing portion,
wherein the trailing portion is longer than the leading portion by at least a factor of 2.

8. The rotary tool according to claim 1,
wherein the lateral surface comprises a main guide chamfer and an ancillary guide chamfer,
wherein the ancillary guide chamfer trails after the main guide chamfer and terminates at the trailing partial surface.

9. The rotary tool according to claim 1,
wherein the latter comprises at least one coolant channel with a mouth arranged in the flank and on the kink.

10. The rotary tool according to claim 1,
wherein the latter comprises at least one coolant channel with a mouth that trails after the kink.

11. The rotary tool according to claim 1,
wherein the latter is a drill.

12. A method for manufacturing a rotary tool that comprises a main blade, a chip flute, a lateral surface, and a flank, wherein the flank is configured so as to trail after the main blade and extends from the main blade up to the lateral surface and to the chip flute, wherein the flank is configured with a kink and is thus concave, and wherein the kink is configured so as to extend from the lateral surface up to the chip flute and thus divides the flank into a leading partial surface and a trailing partial surface, the method comprising:
ingraining the flank in a grinding step.

13. The method according to claim 12, wherein the entire flank is ingrained in a single grinding step along a single grinding path and with only one grinding wheel.
